(19) United States
(12) Patent Application Publication
(10) Pub. No.: US 2008/0065992 A1
(43) Pub. Date: Mar. 13, 2008

(54) CASCADED DISPLAY OF VIDEO MEDIA

(75) Inventors: Jeffrey Ma, Redwood City, CA (US); Rainer Brodersen, San Jose, CA (US); Jeffrey Robin, Los Altos, CA (US); Thomas Michael Madden, Sunnyvale, CA (US); Mihnea Calin Pacurariu, Los Gatos, CA (US); Rachel Clare Goldeen, Mountain View, CA (US)

Correspondence Address: FISH & RICHARDSON P.C., PO BOX 1022, MINNEAPOLIS, MN, 55440-1022, US

(73) Assignee: Apple Computer, Inc., Cupertino, CA (US)

(21) Appl. No.: 11/620,876

(22) Filed: Jan. 8, 2007

Related U.S. Application Data
(63) Continuation-in-part of application No. 11/530,665, filed on Sep. 11, 2006.

(51) Int. Cl. G06F 3/00

(52) U.S. Cl. 715/720

(57) ABSTRACT

Instances of media items are generated from a selection of media items. The instances are scaled and rotated within a display environment.

### RELATED APPLICATION

This application is a continuation-in-part of and claims priority to U.S. patent application Ser. No. 11/530,665, filed on Sep. 11, 2006, the entire contents of which are hereby incorporated by reference.

### BACKGROUND

This disclosure is related to media processing systems and methods.

Media devices and systems, such as digital video and audio players, can include multiple functions and capabilities, such as playing stored content, browsing and selecting from recorded content, storing and/or receiving content selected by a user, and the like. These various functions can often be grouped according to content types, e.g., movies, music, television programs, photos, etc.

### SUMMARY

Disclosed herein are systems and methods for presenting media items in an interface environment. In some implementations, a display environment includes a plurality of representations of at least one media item. The plurality of representations are configured to rotate within the display environment. Along with one or more rotation velocities, two or more of the representations may rotate in a common plane. Additionally, other types of motion may be incorporated. For example, the representations may concurrently transition through the display environment to provide the appearance of linear movement of the plurality items. In some implementations, the plurality of representation of the media items are differently scaled versions of the media item representations.

In other implementations, instructions stored on computer readable media are used to cause a processor to perform the operations comprising: selecting a plurality of video items; generating instances for each of the selected video items; and rotating the instances of the video items within the display environment.

In another implementation, a system includes a display generation module, a data store, and an active picture output generator. The display generation engine is executable by a processing device, and configured to provide an active picture output for a user, the active picture output comprising a plurality of media instances comprising a picture. An active picture output generator is configured to retrieve a picture from the data store and to provide the active picture output to the display generation module. The active picture output is generated by the active picture output generator so as to provide an appearance of rotational movement among the media instances based upon output from the active picture output generator.

### BRIEF DESCRIPTION OF THE DRAWINGS

FIG. 1 is a block diagram of a media processing device.

FIG. 2 is a block diagram of a media system.

FIG. 3 is a block diagram of an example media processing system.

FIG. 4 is a block diagram of an example remote control device for the media processing system.

FIG. 5 is an example network environment in which a media processing system in accordance with FIG. 1 can be implemented.

FIGS. 6-13 are block diagrams of example transitions of media items through the display environment.

FIGS. 14-16 are flow diagrams of an example media viewer.

### DETAILED DESCRIPTION

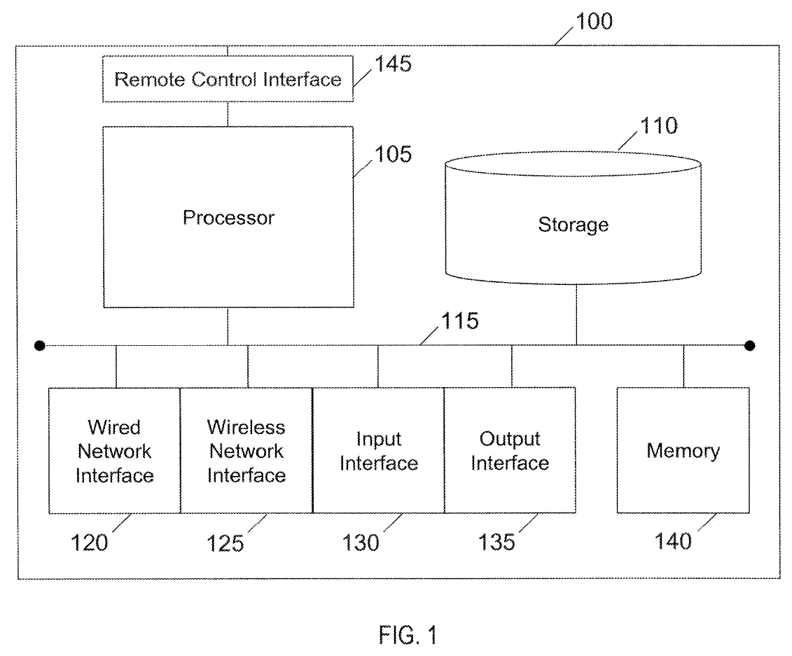

FIG. 1 presents a media processing device 100 that can be configured to present one or more types of media through an output device, including audio, video, images, or any combination thereof. The media processing device 100 includes a processor 105 configured to control the operation of the media processing device 100. For example, the processor 105 can control communications with one or more media servers to receive media for playback. The media can be received through push and/or pull operations, including through downloading and streaming. The processor 105 also can be configured to generate output signals for presentation, such as one or more streams representing media content or an interface for interacting with a user.

The media processing device 100 also includes a storage device 110 that can be configured to store information including media, configuration data, and operating instructions. The storage device 110 can be any type of non-volatile storage, including a hard disk device or a solid-state drive. For example, media received from an external media server can be stored on the storage device 110. The received media thus can be locally accessed and processed. Further, configuration information, such as the resolution of a coupled display device or information identifying an associated media server, can be stored on the storage device 110. Additionally, the storage device 110 can include operating instructions executed by the processor 105 to control operation of the media processing device 100. In one implementation, the storage device 110 can be divided into a plurality of partitions, wherein each partition can be utilized to store one or more types of information and can have custom access control provisions.

A communication bus 115 couples the processor 105 to the other components and interfaces included in the media processing device 100. The communication bus 115 can be configured to permit unidirectional and/or bidirectional communication between the components and interfaces. For example, the processor 105 can retrieve information from and transmit information to the storage device 110 over the communication bus 115. In an implementation, the communication bus 115 may be comprised of a plurality of busses, each of which couples at least one component or interface of the media processing device 100 with another component or interface.

The media processing device 100 also includes a plurality of input and output interfaces for communicating with other devices, including media servers and presentation devices. A wired network interface 120 and a wireless network interface 125 each can be configured to permit the media processing device 100 to transmit and receive information over a network, such as a local area network (LAN) or the Internet. Additionally, an input interface 130 can be configured to receive input from another device through a direct connection, such as a USB or an IEEE 1394 connection. Other types of input interfaces may also be implemented to receive a user input. For example, an input interface may use touch-based operations, near-contact operations or combinations thereof to receive input. For example, an input interface (e.g., a remote control device) may include a proximity detection mechanism that can sense the presence of an input (e.g., a user's finger). As such, a remote control device may sense an input absent user contact with a surface of the remote control device. In some implementations, a user may use a key board and virtually any suitable pointing device (e.g., mouse, track ball, stylus, touch screen, etc.) for interaction. The pointing device can also be operated by a near contact screen that employs a regional sensing field to detect objects in the proximity.

Further, an output interface 135 can be configured to couple the media processing device 100 to one or more external devices, including a television, a monitor, an audio receiver, and one or more speakers. For example, the output interface 135 can include one or more of an optical audio interface, an RCA connector interface, a component video interface, and a High-Definition Multimedia Interface (HDMI). The output interface 135 also can be configured to provide one signal, such as an audio stream, to a first device and another signal, such as a video stream, to a second device. Further, a memory 140, such as a random access memory (RAM) and/or a read-only memory (ROM) also can be included in the media processing device 100. As with the storage device 110, a plurality of types of information, including configuration data and operating instructions, can be stored in the memory 140.

Additionally, the media processing device 100 can include a remote control interface 145 that can be configured to receive commands from one or more remote control devices (not pictured). The remote control interface 145 can receive the commands through wireless signals, such as infrared and radio frequency signals. The received commands can be utilized, such as by the processor 105, to control media playback or to configure the media processing device 100. Similar to the input interface mentioned above, the remote control interface may receive commands from remote control devices that implement touch-based operations, near-contact operations or combinations thereof.

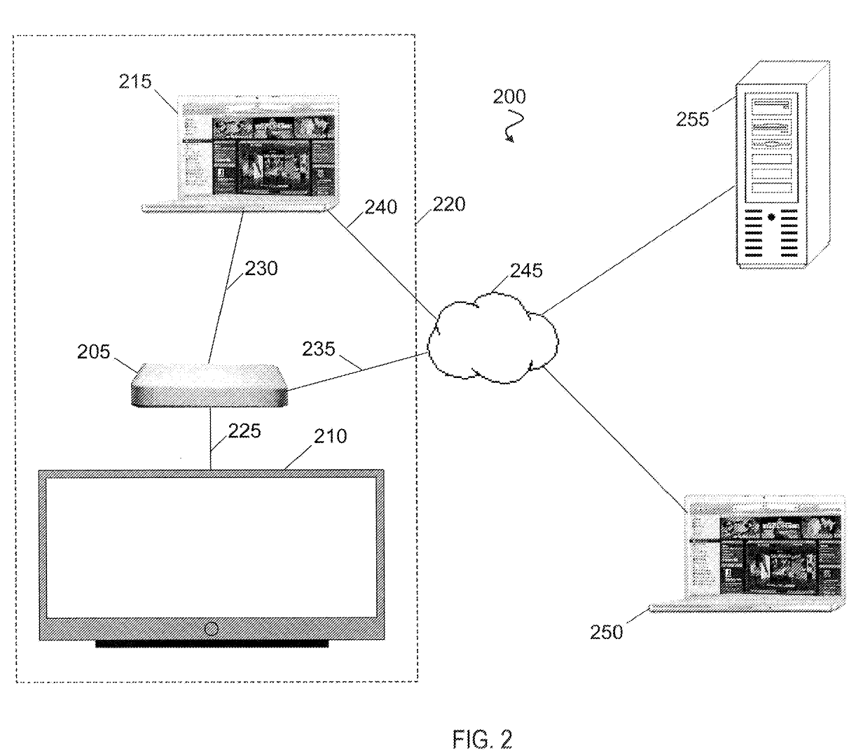

FIG. 2 presents a media system 200 that includes a media processing device 205. The media system 200 includes a host location 220, such as a home or office, in which the media processing device 205 is installed. The host location 220 also can include a local media server 215 and a presentation device, such as a monitor 210. The monitor 210 can be coupled to the media processing device 205 through a media connector 225, such that video and/or audio information output by the media processing device 205 can be presented through the monitor 210. Further, the media processing device 205 can be coupled to the local media server 215 through a local connection 230, such as a wired network connection, a wireless network connection, a direct connection, or other similar connection technique. As such, the media processing device 205 can receive media content from the local media server 215. The local media server 215 can be any computing device, including a personal computer, a server, a palm top computer, or a media device capable of storing and/or playing back media content.

Further, the media processing device 205 and the local media server 215 can include network connections 235 and 240 respectively, which provide access to a network 245, such as the Internet. In one implementation, the media processing device 205 can communicate with a remote media server 250 and/or a media store 255 over the network 245. For example, a connection can be established between the media processing device 205 and the remote media server 250. The connection can be secure or un-secure. Thereafter, the media processing device 205 can receive media content from the remote media server 250, such as by streaming or downloading.

Similarly, the media processing device 205 can be configured to receive media content from a media store 255. For example, upon establishing a connection, the media processing device 205 can request a list of available media content from the media store 255. The list of available media content can include free content, such as trailers and pod casts, and for-purchase content, such as movies, television programs, and music. Additionally, the media processing device 205 can be configured to communicate with the media store 255 to validate media content, such as by verifying digital rights management information. Other types of media devices and systems may also used.

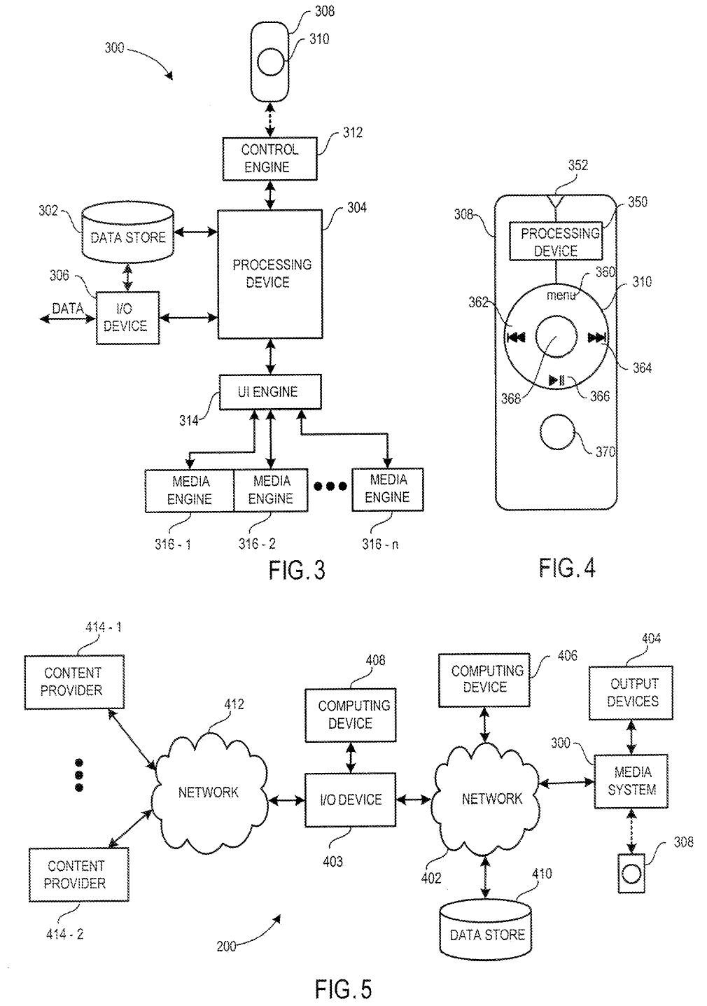

FIG. 3 presents a block diagram of an exemplary media processing system 300. The media processing system 300 can transmit and receive media data and data related to the media data. The media data can be stored in a data store 302, such as a memory device, and be processed by a processing device 304 for output on a display device, such as a television, a computer monitor, a game console, a hand held portable device, and the like, and/or an audio device, such as a multi-channel sound system, a portable media player, a computer system, and the like. The media processing system 300 may be used to process media data, for example, video data and audio data received over one or more networks by an input/output (I/O) device 306. Such media data may include metadata, e.g., song information related to audio data received, or programming information related to a television program received.

The media data and related metadata may be provided by a single provider, or may be provided by separate providers. In one implementation, the media processing system 300 can be configured to receive media data from a first provider over a first network, such as a cable network, and receive metadata related to the video data from a second provider over a second network, such as a wide area network (WAN). Example media data include video data, audio data, content payload data, or other data conveying audio, textual and/or video data.

In another implementation, the media processing system 300 can be configured to receive media data and metadata from a computing device, such as a personal computer. In one example of this implementation, a user manages one or more media access accounts with one or more content providers through the personal computer. For example, a user may manage a personal iTunes® account with iTunes® software, available from Apple Computer, Inc. Media data, such as audio and video media data, can be purchased by the user and stored on the user's personal computer and/or one or more data stores. The media data and metadata stored on the personal computer and/or the one or more data stores can be selectively pushed and/or pulled for storage in the data store 302 of the media processing system 300.

In another implementation, the media processing system 300 can be used to process media data stored in several data stores in communication with a network, such as wired and/or wireless local area network (LAN), for example. In one implementation, the media processing system 300 can pull and/or receive pushed media data and metadata from the data stores over the network for presentation to a user. For example, the media processing system 300 may be implemented as part of an audio and video entertainment center having a video display device and an audio output device, and can pull media data and receive pushed media data from one or more data stores for storage and processing. At the entertainment center, a user can, for example, view photographs that are stored on a first computer while listening to music files that are stored on a second computer.

In one implementation, the media processing system 300 includes a remote control device 308. The remote control device 308 can include a rotational input device 310 configured to sense touch actuations and generate remote control signals therefrom. The touch actuations can include rotational actuations, such as when a user touches the rotational input device 310 with a digit and rotates the digit on the surface of the rotational input device 310. The touch actuations can also include click actuations, such as when a user presses on the rotational input device 310 with enough pressure to cause the remote control device 308 to sense a click actuation.

In one implementation, the functionality of the media processing system 300 is distributed across several engines. For example, the media processing system 300 may include a controller engine 312, a user interface (UT) engine 314, and one or more media engines 316-1, 316-2, and 316-n. The engines may be implemented in software as software modules or instructions, or may be implemented in hardware, or in a combination of software and hardware.

The control engine 312 is configured to communicate with the remote control device 308 by a link, such as a wireless infrared signal or radio frequency signal. The remote control device 308 can transmit remote control signals generated, for example, from touch actuations of the rotational input device 310 to the control engine 312 over the link. In response, the control engine 312 is configured to receive the remote control signals and generate control signals in response. The control signals are provided to the processing device 304 for processing.

The control signals generated by the control engine 312 and processed by the processing device 304 can invoke one or more of the UT engine 314 and media engines 316-1-316-n. In one implementation, the UT engine 314 manages a user interface to facilitate data presentation for the media engines 316-1-316-n and functional processing in response to user inputs.

In one implementation, the media engines 316 can include one or more content-specific engines, such as a movies engine, television program engine, music engine, and the like. Each engine 316 can be instantiated to support content-specific functional processing. For example, a movie engine to support movie-related functions can be instantiated by selecting a “Movies” menu item. Example movie-related functions include purchasing movies, viewing movie previews, viewing movies stored in a user library, and the like. Likewise, a music engine to support music-related functions can be instantiated by selecting a “Music” menu item. Example music-related functions include purchasing music, viewing music playlists, playing music stored in a user library, and the like.

The media processing system 300 of FIG. 3 can also implement different functional distribution architectures that have additional functional blocks or fewer functional blocks. For example, the engines 316 can be implemented in a single monolithic engine.

FIG. 4 is a block diagram of an example remote control device 308 for the media processing system 300. The remote control device 308 includes a rotational input device 310, a processing device 350, and a wireless communication subsystem 352. The rotational input device 310 defines a surface that can sense a touch actuation, such as the presence of a finger on the surface, and can further generate a control signal based on a rotation of the finger on the surface. In one implementation, a touch sensitive array is disposed beneath the surface of the rotational input device 310. The touch sensitive array can be disposed according to polar coordinates, i.e., r and Θ, or can be disposed according to Cartesian coordinates, i.e., x and y, or other similar coordinate system.

The rotational input device areas 360, 362, 364, 366 and 368 are receptive to press actuations. In one implementation, the areas include a menu area 360, a reverse/previous area 362, a play/pause area 364, a forward/next area 366, and a select area 368. The areas 360-368, in addition to generating signals related to their descriptive functionalities, can also generate signals for context-dependent functionality. For example, the menu area 360 can generate signals to support the functionality of dismissing an onscreen user interface, and the play/pause area 364 can generate signals to support the function of drilling down into a hierarchal user interface. In one implementation, the areas 360-368 comprise buttons disposed beneath the surface of the rotational input device 310. In another implementation, the areas 360-368 comprise pressure sensitive actuators disposed beneath the surface of the rotational input device 310.

The processing device 350 is configured to receive the signals generated by the rotational input device 310 and generate corresponding remote control signals in response. The remote control signals can be provided to the communication subsystem 352, which can wirelessly transmit the remote control signals to the media processing system 300.

Although shown as comprising a circular surface, in another implementation, the rotational input device 310 can comprise a rectangular surface, a square surface, or some other shaped surface. Other surface geometries that accommodate pressure sensitive areas and that can sense touch actuations may also be used, e.g., an oblong area, an octagonal area, etc.

Other actuation area configurations may also be used. For example, in another implementation, the remote control device 308 can also include a separate actuation button 370. In this implementation, the areas comprise a “+” or increase area 360, a reverse/previous area 362, a “−” or decrease area 364, a forward/next area 366, a play/pause area 368, and a menu area 370.

FIG. 5 is an example network environment 400 in which a media processing system 300 in accordance with FIG. 1 may be implemented. The media processing system 300 receives, for example, user input through a remote control device 308 and media data over a network 402, such as a wired or wireless LAN. In one implementation, the network 402 communicates with a wide area network 412, such as the Internet, through an I/O device 403, such as a router, server, cable modem, or other computing and/or communication processing device. The media processing system 300 processes the media data for output to one or more output devices 404. The media processing system 300 can receive the media data from one or more data stores connected to the network 402, such as computing devices 406 and 408, and a data store 410.

The media data can be received through the network 412 by one of the computing devices, such as computing device 408. The network 412 can include one or more wired and wireless networks, such as the Internet. The media data is provided by one or more content providers 414. For example, the content provider 414-1 may provide media data that is processed by the media processing system 300 and output through the output devices 404, and the content provider 414-2 may provide metadata related to the media data for processing by the media processing system 300. Such metadata may include episodic content, artist information, and the like. A content provider 414 can also provide both media data and related metadata.

In one implementation, the media processing system 300 can also communicate with one or more content providers 414 directly. For example, the media processing system 300 can communicate with the content providers the wireless network 402, the I/O device 403, and the network 412. The media processing system 300 can also communicate with the content providers 414 thorough other network configuration, e.g., through a direct connection to a cable modem, through a router, or through one or more other communication devices. Example communications can include receiving sales information, preview information, or communications related to commercial transactions, such as purchasing audio files and video files.

In another implementation, the media processing system 300 can receive content from any of the computing devices 406 and 408, and other such computing devices or data stores 410 available on the network 402 through sharing. Thus, if any one or more of the computing devices or data stores are unavailable, media data and/or meta data one the remaining computing devices or other such computing devices or data stores can still be accessed.

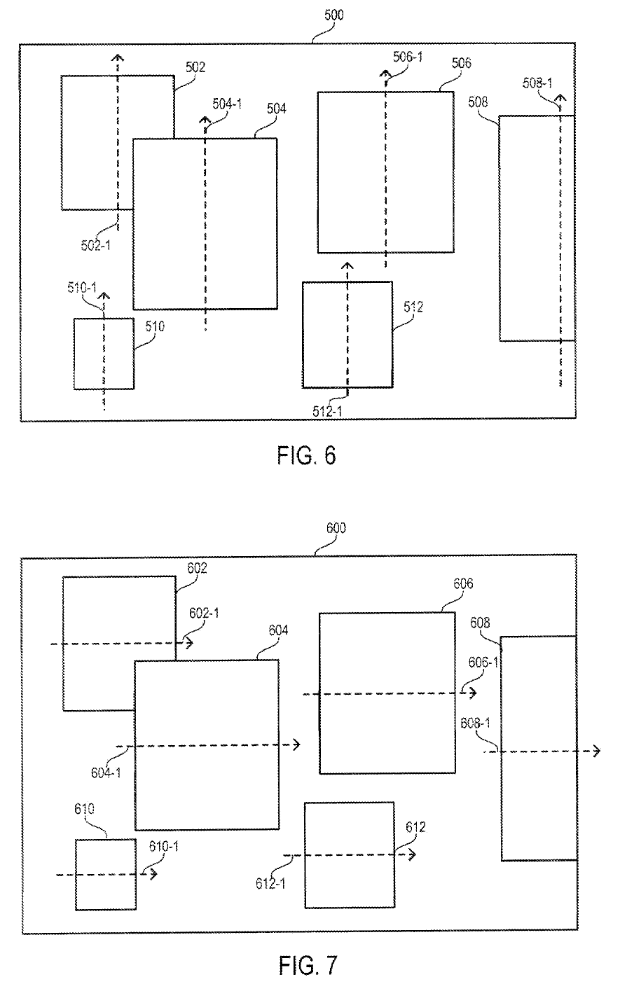

FIG. 6 is a block diagram of an example transition of media items 502-512 (e.g., video items) through the display environment 500. The media items 502-512 transition through the display environment 500 along respective paths 502-1, 504-1, 506-1, 508-1, 510-1, 512-1. The transitioning of the media items 502-512 can provide the appearance of movement in a vertical direction. In one example, the movement can be an upward direction. In other examples, the movement can be in a downward direction. In further examples, the movement of different media items can be in different directions (e.g., both up and down).

In some implementations, the media items 502-512 can include digital representations of photographs, video clips, movies, promotional media, or combinations thereof. In some implementations, the media items 502-512 can be retrieved from among media items stored in the data store 302 of FIG. 3. A media engine can generate instances of the media items 502-512 and scale the instances to fit within the display environment. Another media engine can transition the instances of the media items 502-512 through the display environment 500. In some examples, the media engines performing the generation, scaling and transitioning of the instances can be combined into a single media engine.

Moreover, once an instance of a media item 502-512 transitions through and exits from the display environment 500, a new media item can be retrieved from the data store 302 to replace the exiting media item 502-512. An instance for the new media item can be generated and transitioned on and through the display environment 500. In some example implementations, the number of instances of media items 502-512 in the display environment 500 can be variable. For example, the number of instances of media items 502-512 can vary based upon user preferences (e.g., input through a user interface engine). Alternatively, the number of instances of media items 502-512 can vary quasi-randomly. Furthermore, in some examples, it is not necessary that an instance exit the display environment 500 before another instance of a media item enters the display environment 500. In these display environments 500 the instances of media can be randomly transitioned into the display environment 500. A pre-set limit (e.g., user defined, program defined, etc.) can define an upper limit to the number of instances displayed within the display environment at a single time, the number of instances that appear on a single path, etc.

In some implementations, the instances of the media items can be quasi-randomly scaled to provide the appearance of depth to the display environment. The scaling of the instances of the media items can be maintained while the instances of media items are displayed in the display environment. Instances of new media items can be quasi-randomly scaled prior to being transitioned into the display environment 500. Further, in some implementations, media items can be scaled as they transition along a path, e.g., changing scale as they change position along the path.

In further implementations, the instances of media items may be selectable by the user. For example, the user can select media item instance 510 by clicking on the instance using an input device (e.g., a mouse pointer representation). Media item instance 510 can then be enlarged, thereby providing a better view of the selected media item, while maintaining the transitioning of the media item instances through the display environment.

FIG. 7 is a block diagram of another example transition of media items 602-612 (e.g., video items) through the display environment 600. The media items 602-612 transition through the display environment 600 along respective paths 602-1, 604-1, 606-1, 608-1, 610-1, 612-1. The transitioning of the media items 602-612 can provide the appearance of movement in a horizontal direction. In one example, the movement can be a rightward direction. In other examples, the movement can be in a leftward direction. In further examples, the movement of different media items can be in different directions (e.g., both left and right).

As discussed above, instances of the media instances 602-612 can be generated and scaled for display in a display environment 600. In some implementations, the scaling of the instances can be quasi-random, to provide the appearance of depth to the display environment 600. Moreover, as various instances of the media items 602-612 transition out of the display environment 600, replacement media items can be selected to replace any of the media items transitioning out of the display environment 600. In some example implementations, the number of instances of media items 602-612 in the display environment 600 can be variable. In such instances, the number of instances of media items 602-612 can vary based upon user preferences (e.g., input through a user interface engine). Alternatively, the number of instances of media items 602-612 can vary quasi-randomly. Furthermore, in some examples, it is not necessary that an instance exit the display environment 600 before another instance of a media item enters the display environment 600. In these display environments 600 the instances of media can be randomly transitioned into the display environment 600. A pre-set limit (e.g., user defined, program defined, etc.) can define an upper limit to the number of instances displayed within the display environment at a single time.

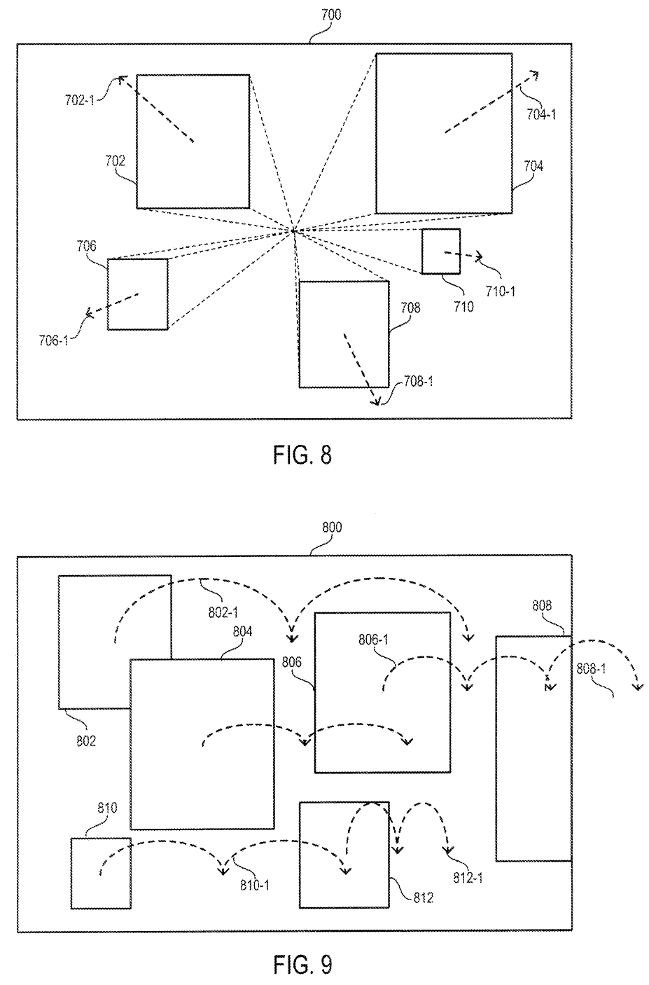

FIG. 8 is a block diagram of another example transition of media items 702-710 (e.g., video items) through the display environment 700. The media items 702-710 transition through the display environment 700 along respective paths 702-1, 704-1, 706-1, 708-1, 710-1. The transitioning of the media items 702-710 can provide the appearance of movement along a path originating from a vanishing point, which, in conjunction with increasing or decreasing the scaling of an instance of the media items, provides the appearance of movement along a three dimensional path. In one example, the media items can appear to move in an oncoming direction through the display environment 700. In other examples, the media items can appear to move away from the user through the display environment 700. In further examples, the movement of different media items can be in different directions (e.g., both oncoming and exiting).

As discussed above, instances of the media instances 702-710 can be generated and scaled for display in a display environment 700. Moreover, as various instances of the media items 702-710 transition out of the display environment 700, replacement media items can be selected to replace any of the media items transitioning out of the display environment 700.

In some example implementations, transitioning the instances of media items forward in the display environment can include intermittent pauses. The intermittent pauses can allow the user to view the instances of media items in a foreground position for a period of time before continuing to transition a next layer of media item instances forward to the foreground position.

For example, in some implementations there can be several layers of instances of digital photos. The first layer can correspond, for example, to a foreground position, while the second and third through n-th layers can correspond, for example, to increasingly smaller scale photographs. The transitioning would pause for a period of time having the first layer in the foreground position. After expiration of a period of time, the first layer can transition out of the display environment and the second layer can transition into a foreground position, while the third through n-th layers are transitioned to the next larger scale (e.g., the original scale of the second layer digital photos). The display environment can display the second layer in the foreground position for a period of time, and then continue to successively transition the third through n-th layers through the foreground position, with foreground pauses for each successive layer. Moreover, in implementations where there are numerous layers, for example, the n-th layer might not initially appear in the display environment. In various implementations, the display environment can be limited by the programmer or the user to displaying four levels of images. In these implementations, each successive transition of a layer out of the display environment can be complemented by a new layer transitioning into the display environment.

FIG. 9 is a block diagram of another example transition of media items 802-812 (e.g., video items) through the display environment 800. The media items 802-812 transition through the display environment 800 along their respective paths 802-1, 804-1, 806-1, 808-1, 810-1, 812-1. The transitioning of the media items 802-812 can provide the appearance of the media items bouncing across the screen. In one example, the bouncing movement can be a rightward direction. In other examples, the bouncing movement can be in a leftward direction. In further examples, the bouncing movement of different media items can be in different directions (e.g., both left and right).

As discussed above, instances of the media instances 802-812 can be generated and scaled for display in a display environment 800. In some implementations, the scaling of the instances can be quasi-random, to provide the appearance of depth to the display environment 800. Moreover, the height or amplitude and/or the length associated with the bouncing movement can be quasi-random, or controlled by input received from the user. Further, as various instances of the media items 802-812 transition out of the display environment 800, replacement media items can be selected to replace any of the media items transitioning out of the display environment 800. In various other examples, the paths of movement can be a quasi-random linear path or any other type of path.

In the previous example, the media items transition along one or more paths along a display environment, however, the media items may also exhibit other types of movement such as rotation motion. These different types of movements may be exhibited independent of, or in combination with transitions along one or more paths.

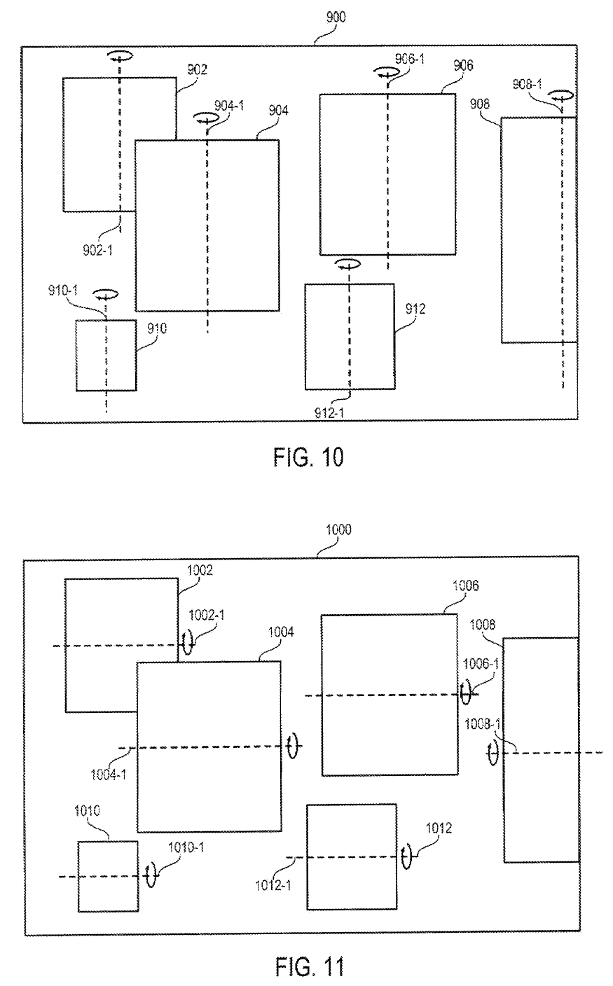

FIG. 10 is a block diagram that illustrates media items exhibiting rotational motion. In particular, media items 902-912 (e.g., video items) rotate within a display environment 900. The media items 902-912 rotate about respective axes 902-1, 904-1, 906-1, 908-1, 910-1, 912-1. Media item characteristics and graphical characteristics (mentioned in the previous examples) may also be implemented in the rotating media items 902-912. For example, along with rotating, the media items 902-912 may transition through the display environment 900. One or more of the media items 902-912 may exhibit similar or different rotational characteristics. For example, two or more of the media items 902-912 may exhibit different or equivalent rotational velocities. Furthermore, axis orientation may be similar or different for the media items 902-912. While this illustration presents each of the axes 902-1-912-1 being vertically oriented, in some arrangements, one or more media items may rotate about a differently oriented axis. For example, referring to FIG. 11, media items 1002-1012 are illustrated respectively rotating about horizontally oriented axes 1002-1, 1004-1, 1006-1, 1008-1, 1010-1, 1012-1.

Rotational axes may also be orientated at other angular positions such as angles between vertical orientation (θ=0°) and horizontal orientation (θ=90°) or other angles. Media items may also overlap as illustrated by media items 902 and 904 (shown in FIG. 10) and media items 1002 and 1004 (shown in FIG. 11). As illustrated in FIG. 10, each of the media items 902-912 are oriented in equivalent starting angular positions, however, two or more of the media items may have different starting angular positions. Similarly, the media items 1002-1012 may be oriented in equivalent angular positions (as shown in FIG. 11) or in different angular positions.

Rotational axis orientation may also change over a period of time. For example, over the course of a predefined time period, one or more of the axes 902-1-912-1 may change from one orientation (e.g., vertical orientation shown in FIG. 10) to another orientation angle (e.g., horizontal orientation shown in FIG. 11) or transition through a range of orientation angles. One or more rotation directions may also be implemented, for example, clockwise rotations, counterclockwise rotations, and combinations of rotations may be implemented. Along with rotating about individual axes, the media items 902-912 may be grouped to rotate about one or more common axes.

As discussed above, instances of the media items 902-912 (and 1002-1012) can be generated and scaled for display in the respective display environment 900 (and display environment 1000). In some implementations, the scaling of the instances can be quasi-random, to provide the appearance of depth to the respect display environments 800, 900. Moreover, the rotation position and/or rotational velocity associated with the rotational motion can be quasi-random, or controlled by input received from the user. Further, as various instances of the media items 902-912 rotating within the display environment 900 (or media items 1002-1012 rotating within display environment 1000), replacement media items can be selected to replace any of the media items rotating within the respective display environments 900, 1000. In various other examples, rotational velocity associated with one or more media items 902-912 (or 1002-1012) may vary based upon a deterministic or quasi-random angular acceleration or by another manner.

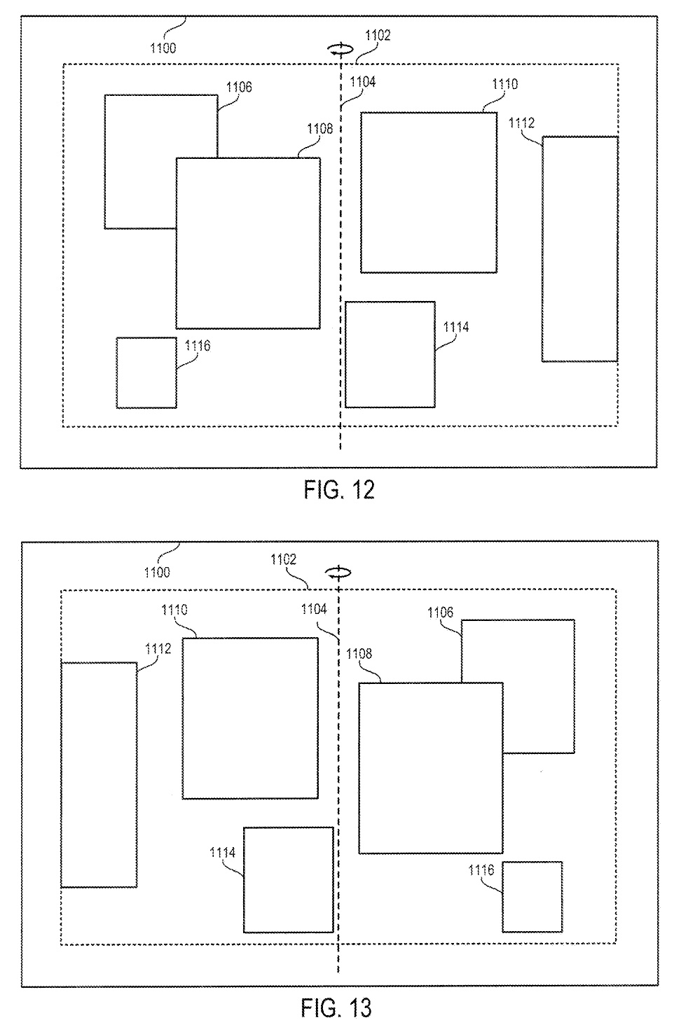

FIGS. 12 and 13 each include block diagrams that illustrate another example of media items exhibiting rotational motion within a display environment 1100. In particular media items 1106-1116 are grouped to rotate together about an axis 1104 on a common plane 1102. As illustrated in FIG. 12, the media items 1106-1116 are shown distributed across the display environment 1100 on the common plane 1102. Referring to FIG. 13, the positions of the media items 1106-1116 have changed by rotating the common plane 1102 by 180° about the axis 1104. Rotation may continue about the axis 1104, to return the media items to the positions illustrated in FIG. 12, and then continue in a repetitive manner.

In this example, one rotational direction (e.g., clockwise) has been selected, however, in other implementations another rotational direction (e.g., counterclockwise) may be selected. Also, in this illustration, all of the media items 1106-1116 are grouped onto a single plane (i.e., common plane 1102). However, in other scenarios, the media items 1106-1116 may be grouped onto multiple planes. For example, referring to FIG. 12, media items 1106, 1108 and 116 may be grouped for inclusion in one plane and media items 1110, 1112 and 1114 may be grouped for inclusion in another plane. These two distinct planes may be independently rotated about separate axes or rotated about the same axis. In still another example, some of the media items 1106-1116 may be grouped onto a common plane for rotating about a common axis while other media items may rotate independently as illustrated in FIG. 10 and FIG. 11.

Furthermore, in some implementations, the display environment can be configured to use any of the aforementioned transitions in combination with any other rotations and transitions. For example, the upward/downward transition shown in FIG. 6 can be combined with the rotation described with respect to FIG. 10. Thus, while instances of media items are transitioning upward, the instances of media items can, for example, rotate clockwise or counterclockwise. Other implementations of transitions and combinations of transitions are also possible.

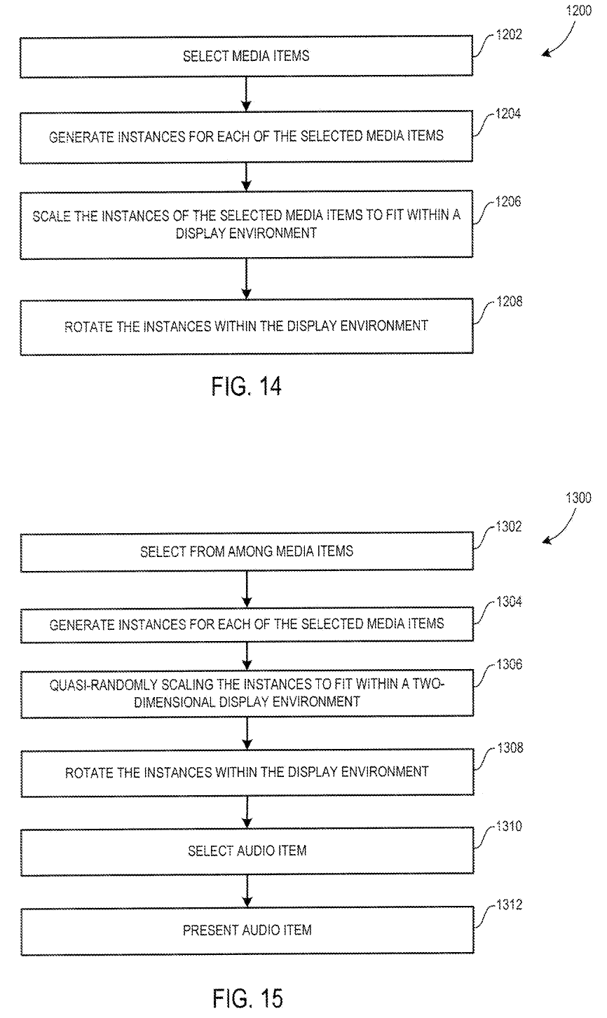

FIG. 14 is a flow diagram 1200 of an example process for viewing media, in for example a media viewer. Media items are selected in step 1202. For example, media items can be quasi-randomly selected by a corresponding media engine 316-1, 316-2, 316-n (e.g., a media selection engine configured to select media items from a data store 302 of FIG. 3). Alternatively, the media items can be selected based upon input received from the user through a user interface 314 of FIG. 3. In yet a further example, the media items can be remotely located and selected using a network The media items in various examples can include digital representations of pictures (e.g. photographs), video clips, movie clips, promotional media (e.g., movie poster, album cover, etc.). In some implementations, the movie clips can be supplemented by associated promotional media (e.g., a movie poster), thereby enabling the user to obtain information about the movie clip.

In step 1204, instances for each of the selected media items are generated. For example, the instances of the selected media items can be generated by a corresponding media engine 316-1, 316-2, 316-n (e.g., a presentation engine configured to receive data and render graphics to a display device).

Optionally, in step 1206, the instances of the media items are scaled. For example, the instances of the media items can be scaled by a corresponding media engine 316-1, 316-2, 316-n (e.g., a presentation engine). The instances of the media items can be scaled such that the media items fit within a display environment. In some examples, the display environment can include, among others, a screen saver, a media presentation, a slideshow viewer, a library player, or an audio player. Scaling can also be used to give the appearance of depth or emphasis as desired. Scaling can occur prior to rendering the media item a first time or as the item is transitioned along a path in the display environment.

In step 1208, the instances of the media items can be rotated within the display environment. For example, the instances of the selected media items can be rotated by a corresponding media engine 316-1, 316-2, 316-n (e.g., a presentation engine). In some implementations, the instances of the media items may also be transitioned, for example, using sequential refreshing of the instances in slightly different locations, thereby providing the appearance to a user of movement (e.g., linear movement) along a path through the display environment.

Moreover, the instances of media items can be rotated and transitioned at different rates. Rotating and transitioning the instances of media items at different rates, can add to the appearance of depth to the display environment. For example, items that are scaled larger can be rotated or transitioned at a faster rate than items that are scaled smaller. The rate of rotation and transition for a media item that can be linearly proportional to the scaled size of the media item. Thus, small items can have a slower rotation or transition rate, while larger items can have a faster rotation or transition rate. Rotating and transitioning the media items at different rates can also help to prevent a larger item from covering a smaller item as both of the items appear on the display environment.

Further paths which different media items use to transition through the display environment can intersect with each other in some examples. In some implementations, when paths of the media item instances intersect, an instance which is scaled larger can take precedence (e.g., the larger instance can be drawn on top of the smaller instance).

FIG. 15 is another flow diagram 1300 of an example media viewing process. In step 1302, a selection is made from among media items. For example, media items can be quasi-randomly selected by a corresponding media engine (e.g., media selection engine configured to quasi-randomly select media items from a data store 302 or a network interface). Alternatively, the media items can be selected based upon input received from the user through a user interface 314 of FIG. 3. In yet further examples, the media can be remotely located and selected using a network The media items in various examples can include digital representations of pictures (e.g. photographs), video clips, movie clips, promotional media (e.g., movie poster, album cover, etc.). In some implementations, the movie clips can be supplemented by associated promotional media (e.g., a movie poster), thereby enabling the user to obtain information about the movie clip.

In step 1304, instances for each of the selected media items are generated. For example, the instances of the selected media items can be generated by a corresponding media engine 316-1, 316-2, 316-n (e.g., a presentation engine).

Optionally, in step 1306, the instances of the media items are quasi-randomly scaled. For example, the instances of the media items can be quasi-randomly scaled by a corresponding media engine 316-1, 316-2, 316-n (e.g., a presentation engine). The instances of the media items can be scaled such that the media items fit within a display environment. In some examples, the display environment can include, among others, a screen saver, a media presentation, a slideshow viewer, a library player, or an audio player.

In step 1308, the media viewer rotates the instances of the media items within the display environment. For example, the instances of the selected media items can be rotated within the display environment by a corresponding media engine 316-1, 316-2, 316-n (e.g., a presentation engine). In some implementations, the instances of the media items may also be transitioned, for example, using sequential refreshing of the instances in slightly different locations, thereby providing the appearance to a user of movement (e.g., linear movement) along a path through the display environment.

In step 1310, an audio item is selected. The audio item can be selected, for example, based upon user input received through the user interface 314 of FIG. 3. Alternatively, the audio item may be quasi-randomly selected from an audio library by an audio selection engine from among the media engines 316-1, 316-2, 316-n, the audio selection engine being configured to enable the user to select audio content or being configured to quasi-randomly select audio content.

In step 1312, the audio item is presented. Alternatively, the audio item may be presented using an audio interface engine selected from among the media engines 316-1, 316-2, 316-n, the audio interface engine being configured to generate audio signals suitable for output to speakers based upon received data. In some implementations, the audio item can correspond to at least one of the media items from which a selection is made. For example, promotional media (e.g., album art) associated with the audio item can be mixed among the media items for selection in step 1302. Thus, the display environment can present the promotional material, alerting the user to the audio that is playing.

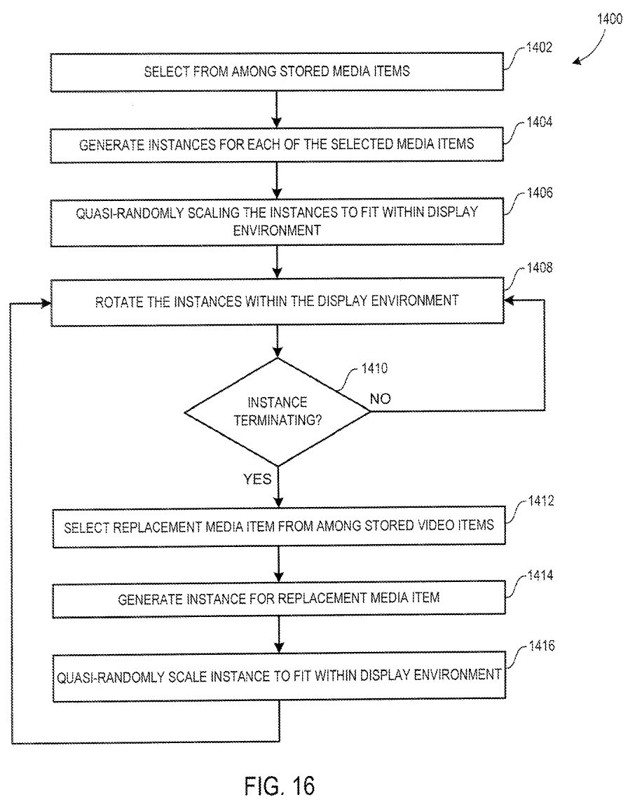

FIG. 16 is another flow diagram 1400 of an example media viewing process. Media items are selected from among stored media items in step 1402. For example, media items can be quasi-randomly selected by a corresponding media engine 316-1, 316-2, 316-n (e.g., a media selection engine configured to quasi-randomly select media items from a data store 302). Alternatively, the media items can be selected based upon input received from the user through a user interface 314 of FIG. 3. The media items in various examples can include digital representations of pictures (e.g. photographs), video clips, movie clips, promotional media (e.g., movie poster, album cover, etc.).

In step 1404, the instances of each of the selected media items are generated. For example, the instances of the selected media items can be generated by a corresponding media engine 316-1, 316-2, 316-n (e.g., a presentation engine).

Optionally, in step 1406, the instances of the media items are quasi-randomly scaled. For example, the instances of the media items can be quasi-randomly scaled by a corresponding media engine 316-1, 316-2, 316-n (e.g., a presentation engine). The instances of the media items can be quasi-randomly scaled such that the media items fit within a display environment. In some examples, the display environment can include, among others, a screen saver, a media presentation, a slideshow viewer, a library player, or an audio player.

In step 1408, the instances of the media items are rotated within the display environment. For example, the instances of the selected media items can be rotated by a corresponding media engine 316-1, 316-2, 316-n (e.g., a presentation engine). In some implementations, the instances of the media items may also be transitioned, for example, using sequential refreshing of the instances in slightly different locations, thereby providing the appearance to a user of movement (e.g., linear movement) along a path through the display environment.

Step 1410 determines whether any of the instances of the media items are terminating from the display environment. As an example, step 1410 can be performed by a corresponding media engine 316-1, 316-2, 316-n (e.g., presentation engine). When there are no instances of the media items that are terminating from the display environment, the instances of the media items continue to be rotated within the display environment. When any of the instances of the media items are terminating from the display environment, replacement media items are selected in step 1412. Replacement media items can be quasi-randomly selected by a media selection engine from a data store 302. Alternatively, the media items can be selected base upon input received from the user through a user interface 314 of FIG. 3. For example, termination can arise when a media item has transitioned to an end of path that is defined for the display environment (e.g., the media item is transitioned off the edge of the screen). Alternatively, a media item may be transitioned when a predetermined time out has expired (e.g., the media item is terminated after it has navigated the associated path a predetermined number of cycles or after a predetermined amount of time).

In step 1414 instances for any replacement media items are generated. For example, the instances of the replacement media items can be generated by a corresponding media engine 316-1, 316-2, 316-n (e.g., a presentation engine).

Optionally, in step 1416, the instances of any replacement media items are quasi-randomly scaled. For example, the instances of the replacement media items can be quasi-randomly scaled by a corresponding media engine 316-1, 316-2, 316-n (e.g., a presentation engine). Any instances of the replacement media items can be quasi-randomly scaled such that the media items fit within the display environment. The scaled instances of the replacement media items can be transitioned with other instances in step 1408.

The apparatus, methods, flow diagrams, and structure block diagrams described in this patent document can be implemented in computer processing systems including program code comprising program instructions that are executable by the computer processing system. Other implementations can also be used. Additionally, the flow diagrams and structure block diagrams described in this patent document, which describe particular methods and/or corresponding acts in support of steps and corresponding functions in support of disclosed structural means, can also be utilized to implement corresponding software structures and algorithms, and equivalents thereof.

The apparatus, methods, flow diagrams, and structure block diagrams described in this patent document can be implemented in computer processing systems including program code comprising program instructions that are executable by the computer processing system. Other implementations can also be used. Additionally, the flow diagrams and structure block diagrams described in this patent document, which describe particular methods and/or corresponding acts in support of steps and corresponding functions in support of disclosed structural means, can also be utilized to implement corresponding software structures and algorithms, and equivalents thereof.

The methods and systems described herein may be implemented on many different types of processing devices by program code comprising program instructions that are executable by one or more processors. The software program instructions may include source code, object code, machine code, or any other stored data that is operable to cause a processing system to perform methods described herein.

The systems and methods may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions and data structures described herein may be connected directly or indirectly to each other in order to allow the flow of data needed for their operations. It is also noted that software instructions or a module can be implemented for example as a subroutine unit of code, or as a software function unit of code, or as an object (as in an object-oriented paradigm), or as an applet, or in a computer script language, or as another type of computer code or firmware. The software components and/or functionality may be located on a single device or distributed across multiple devices depending upon the situation at hand.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art can effect alterations, modifications and variations to the examples without departing from the scope of the invention.

What is claimed is:

1. One or more computer readable media storing instructions that are executable by a processing device, and upon such execution cause the processing device to perform operations comprising:
selecting a plurality of video items;
generating an instance for each of the selected video items; and
rotating one or more instances of the video items within the display environment.

2. The computer readable media of claim 1, wherein two or more instances of the video items rotate in different planes.

3. The computer readable media of claim 1, wherein two or more instances of the video items rotate in a common plane.

4. The computer readable media of claim 1, wherein two or more instances of the video items rotate at different angular velocities.

5. The computer readable media of claim 1, wherein at least one video item includes a representation of a digital picture.

6. The computer readable media of claim 1, wherein at least one video item includes a representation of one or more movies.

7. The computer readable media of claim 1, wherein at least one video item includes a representation of one or more video clips.

8. The computer readable media of claim 1, further comprising instructions to cause the processing device to perform operations comprising:
concurrently providing audio content during the rotation of the instances of the video items.

9. The computer readable media of claim 1, wherein at least two instances of video items are overlapped in the display environment.

10. The computer readable media of claim 1, wherein at least one instance of the video items concurrently transitions along one or more paths through the display environment.

11. The computer readable media of claim 10, wherein at least one instance of the video items appears to trace a path through the video environment.

12. The computer readable media of claim 11, wherein the path comprises at least one of a quasi-random path, a cascaded rainfall patterned path, a bouncing patterned path, a three-dimensional perspective path, a horizontal panning pattern, or combinations thereof.

13. The computer readable media of claim 1, wherein the display environment is at least one of a screen saver, a slideshow viewer, or a library viewer.

14. The computer readable media of claim 1, wherein the video items are retrieved from a data store.

15. The computer readable media of claim 1, wherein the video items comprise digital representations of media content retrieved through a network interface.

16. The user interface of claim 1, wherein the display environment is configured to render the selecting, generating, scaling and concurrent transitioning of the video items in real time.

17. A method comprising:
selecting a plurality of video items;
generating instances for each of the selected video items;
quasi-randomly scaling the instances of the video items to fit within a subset of a two-dimensional display environment; and
rotating one or more instances of the video items within the display environment.

18. The method of claim 17, wherein the two or more instances of the video items rotate in different planes.

19. The method of claim 17, wherein the two or more instances of the video items rotate in a common plane.

20. The method of claim 17, wherein the two or more instances of the video items rotate at different angular velocities.

21. The method of claim 17, wherein at least one of the video items comprises one or more digital representations of pictures, one or more representations of movies, one or more representations of video clips, or combinations thereof.

22. The method of claim 17, further comprising:
concurrently providing audio content during the rotation of the instances of the video items.

23. The method of claim 17, wherein at least two instances of video items are overlapped in the display environment.

24. The method of claim 17, wherein at least one instance of the video items appears to trace a linear path through the display environment.

25. The method of claim 24, wherein the linear path comprises a pattern, the pattern comprising at least one of a quasi-random pattern, a cascaded rainfall pattern, a bouncing pattern, a three-dimensional perspective pattern, or a horizontal panning pattern, or combinations thereof.

26. The method of claim 17, wherein the two dimensional display environment is at least one of a screen saver, a slideshow viewer, or a library viewer.

27. The method of claim 17, wherein the video items are retrieved from a data store.

28. The method of claim 17, wherein the video items comprise digital representations of media content retrieved through a network interface.

29. The method of claim 17, wherein quasi-randomly scaling the instances of the video items creates the appearance of depth within the two-dimensional display environment.

30. A display environment comprising:
a plurality of representations of at least one media item rotating within the display environment, the plurality of representations of the at least one media item comprising differently scaled versions of the at least one media item.

31. The display environment of claim 30, wherein two or more of representations rotate in different planes.

32. The display environment of claim 30, wherein two or more of the representations rotate in a common plane.

33. The display environment of claim 30, wherein two or more of the representations rotate at different angular velocities.

34. The display environment of claim 30, wherein the display environment comprises a two-dimensional display environment.

35. The display environment of claim 34, wherein the differently scaled versions of the at least one media item generates the appearance of depth within the two-dimensional display environment.

36. The display environment of claim 30, wherein the at least one media item comprises at least one of: a digital representation of a picture, a digital representation of a video clip, or combinations thereof.

37. The display environment of claim 30, wherein at least one representation concurrently transitions along one or more paths through the display environment to provide the appearance of movement.

38. The display environment of claim 37, wherein one path forms a pattern in the display environment comprising at least one of a quasi-random pattern, cascaded rainfall pattern, a bouncing pattern, a three-dimensional pattern, a horizontal panning pattern, or a diagonal pattern, or combinations thereof.

39. A media viewer comprising:
a display generation module configured to provide an active picture output for a user comprising a plurality of media instances, the media instances being based upon at least one picture;
a data store configured to store the at least one picture; and
an active picture output generator configured to provide the active picture output to the display generation module, the active picture output comprising the plurality of media instances;
wherein the active picture output is generated so as to provide an appearance of rotational movement among a plurality of media instances based upon output from the active picture output generator.
